(19) United States
(12) Patent Application Publication
(10) Pub. No.: US 2013/0106573 A1
(43) Pub. Date: May 2, 2013

(54) Room privacy notification

(71) Applicant: Christopher Metcalf Root, Colorado Springs, CO (US)

(72) Inventor: Christopher Metcalf Root, Colorado Springs, CO (US)

(21) Appl. No.: 13/317,884

(22) Filed: Oct. 31, 2011

(51) Int. Cl. G08B 5/22

(52) U.S. Cl. 340/6.1

(57) ABSTRACT

The present invention provides a method and device whereby the occupant of a room can notify those outside the room that the occupant prefers no one enter the room, entry occur only after knocking, or unrestricted entry. Commonly understood symbolism is utilized so that a red indicator notifies that no entry is desired, a yellow indicator notifies that knocking should occur before entry, and a green indicator notifies that unrestricted or silent entry is permitted. The indicators can be remotely controlled by means of a control mechanism inside the room to allow someone inside the room to control the easily understood notice which can be viewed on an exterior wall of the room.

### BACKGROUND OF THE INVENTION

1. Field of the Invention

The present invention relates to a method and device for notifying persons outside a room that the occupant of the room prefers that no one enter the room, prefers that those outside the room enter only after knocking, or prefers unrestricted access to the room.

2. Description of the Prior Art

Several devices are known in the prior art for providing specific notices outside a room. For example, an indicator taught in U.S. Pat. No. 5,861,806 to Vories et al., a signal described in U.S. Pat. No. 7,571,694 to Boerner, and a device taught in U.S. Patent Application 2010/0052894 notify a person outside a room whether the room is occupied or vacant. Because the message communicated by these devices is binary (occupied or not occupied), the notification device may be as simple as whether a light on the device is on or off.

Frequently it is desirable to have multiple messages from which to choose for display on a notification device exterior to a room. For example, mechanisms taught in U.S. Pat. Nos. 4,854,061 to Khoshkish, 6,731,200 to Wagner et al., 7,336,158 to Lombardo, and 7,378,982 to Mohamed provide multiple pre-determined messages from which a person inside the room may select a single notice to be displayed outside the room. U.S. Pat. No. 7,053,757 to Buckingham et al. also provides multiple messages which can be displayed, but the actual message is selected automatically depending on various room control systems, rather than being selected by an occupant of the room. In each case, the pre-determined messages are presented in a particular language, such as English or whatever language is dominant in the culture where the building is located. These devices serve a useful purpose, but do not provide an understandable notice to those who are unable to read or unable to read a particular language.

In numerous settings, such as a room in a home, business conference room, dormitory room, hospital room, and hotel room, occupants of the room may wish to communicate a desire for privacy, a request for entry upon knocking or other notice, or a request to enter the room silently, to those outside the room. Sometimes those to whom the notice is directed are too young to read a language-based message, speak a language other than the one used in a displayed notice, or are unable to understand a displayed notice because of mental incapacity. In these situations, a notification method and device which is capable of providing three different messages without relying on the ability to read a particular language would be advantageous.

### SUMMARY AND OBJECTS OF THE INVENTION

A primary object of the present invention is to provide a method of notifying those outside a room that those inside the room desire privacy, entry only after knocking, or unrestricted access to the room.

Another object of the present invention is to provide a mechanism for providing such a notice which allows an occupant of a room to select from three distinct messages which are communicated outside the room, without the necessity of the recipient of the message being able to read a particular language.

Yet another object of the present invention is to provide such a mechanism which is easily installed and does not detract from interior decor.

These objects are achieved by a notification device which includes a display unit which can be mounted on an exterior wall of a room but is remotely controlled, such as by radio frequencies, from a control mechanism located inside the room. Unlike existing notification devices, the instant invention provides a notification device which utilizes commonly understood symbolism from traffic lights to provide three separate messages which can be selected and communicated even if the recipient of the message does not read a particular language. Thus, an occupant of the room can remotely cause a red indicator to be displayed outside the room to communicate that privacy, or no entry, is desired. The occupant can remotely cause a yellow indicator to be displayed outside the room to notify those outside the room that it is desirable to knock on the door of the room prior to entry. Similarly, the occupant of the room can remotely cause a green indicator to be displayed outside the room to indicate that unrestricted entry is appropriate. In settings such as a hospital room, the green indicator could be utilized to notify potential guests that silent entry, without knocking, is desirable.

To provide ease of installation and avoid detracting from room decor, it is advantageous to provide a display unit for the notification device which has a face which is similar in size and shape to a single gang wall plate. In this manner, electronic components which are commonly known in the art for turning on and off lights or otherwise activating the red/yellow/green indicators can be housed in a single gang box attached to a stud framing the door in the same manner that electronics for a light switch are typically mounted adjacent to a room door. The face of the display unit is a wall plate supporting the red/yellow/green indicators which fits onto and is screwed into the single gang box in the manner commonly used for plates over a light switch.

In an alternative embodiment, a self-contained display unit of any size which houses the electronic components by which the red/yellow/green indicators are activated may be faced by a flat plate holding the actual indicators. Such a self-contained display unit may be removably attached to a wall in the vicinity of a door to the room, such as by adhesive strips.

The indicators may conveniently be colored LED lights or other types of white lights with appropriate tinted lenses.

The control mechanism by which an occupant of the room selects which indicator is displayed may be a transportable hand-held device or a wall-mounted or otherwise stationery control unit. A control unit holder may be mounted on an interior wall of the room to allow the control unit to be held in place in a convenient location, such as next to the door to the room, while permitting the control unit to be easily removed from the holder if it is desirable to move the control unit to other locations within the room. The control mechanism may conveniently have a red indicator, yellow indicator, and green indicator which are illumined to show which indicator is currently displayed on the display unit. A control means, such as a switch or button, may be manually deployed to select which indicator on the display unit is to be activated. A power on/off switch may also be provided.

Typical remote control RF technology is utilized to send commands from the control mechanism to the display unit. In buildings where multiple notification devices are in use, it is advantageous to utilize an identification code for each notification device, so that a particular control mechanism is programmed to control only one display unit associated with that control mechanism.

To make the messages of the notification device most recognizable, it is advisable to arrange the indicators on the face of the display unit so that the red indicator is in a top position, the yellow indicator is in a middle position, and the green indicator is in a bottom position. The similarity of this arrangement to a standard traffic light signal provides the symbolism which makes the notification device easily understood regardless of ability to read a language. If desired, a particular indicator, such as the red indicator, can be made larger than the other two indicators.

It is possible to provide additional messages or notices on each display unit, in addition to the red light, yellow light, and green light. Each such additional message could be selected for display from the control unit, preferably allowing such additional messages to be displayed simultaneously with or independently from the basic red light/yellow light/green light notice.

Power to activate the indicators can be provided to the display unit in numerous well known manners. For example, the display unit may be provided with a self-contained replaceable battery. Alternatively, power may be provided from a low voltage power circuit which may already exist in the building to supply power to an alarm system. A self-contained replaceable battery will typically be most useful to power the control mechanism.

Thus, the notification device of the current invention is ideally suited to enable someone inside a room to remotely determine whether persons outside the room are notified to refrain from entering, to knock before entering, or to enter without restriction or sound.

### BRIEF DESCRIPTION OF THE DRAWINGS

FIG. 1 is a front view of a notification device, according to the present invention.

FIG. 2 is a perspective view of a room having an exterior wall on which is provided a notice which is controlled from inside the room.

FIG. 3 is a rear view of a display unit of the claimed notification device.

In the drawings, the following legend has been used:

| | |
|---|---|
| 10 | Notification device |
| 11 | Display unit |
| 12 | Face of display unit |
| 13 | Electronic components |
| 14 | Wall |
| 16 | Room |
| 17 | Door |
| 18 | Mounting mechanism |
| 20 | Red indicator |
| 22 | Yellow indicator |
| 24 | Green indicator |
| 26 | Top portion of face |
| 28 | Middle portion of face |
| 30 | Bottom portion of face |
| 32 | Control mechanism |
| 34 | Red indicator control |
| 36 | Yellow indicator control |
| 38 | Green indicator control |
| 40 | Power on/off control |
| 42 | Back of display unit |
| 44 | Power source |
| 46 | Mounting bracket |

### DESCRIPTION OF THE PREFERRED EMBODIMENT

The present invention provides a method and device for remotely notifying persons outside a room that the occupants of the room desire no entry, entry after knocking, or unrestricted entry into the room. In the following description, numerous specific details are set forth in order to provide a thorough understanding of the present invention. It will be obvious, however, to one skilled in the art that the present invention may be practiced without these specific details. Some well-known methods and structures have not been set forth in order not to unnecessarily obscure the description of the present invention.

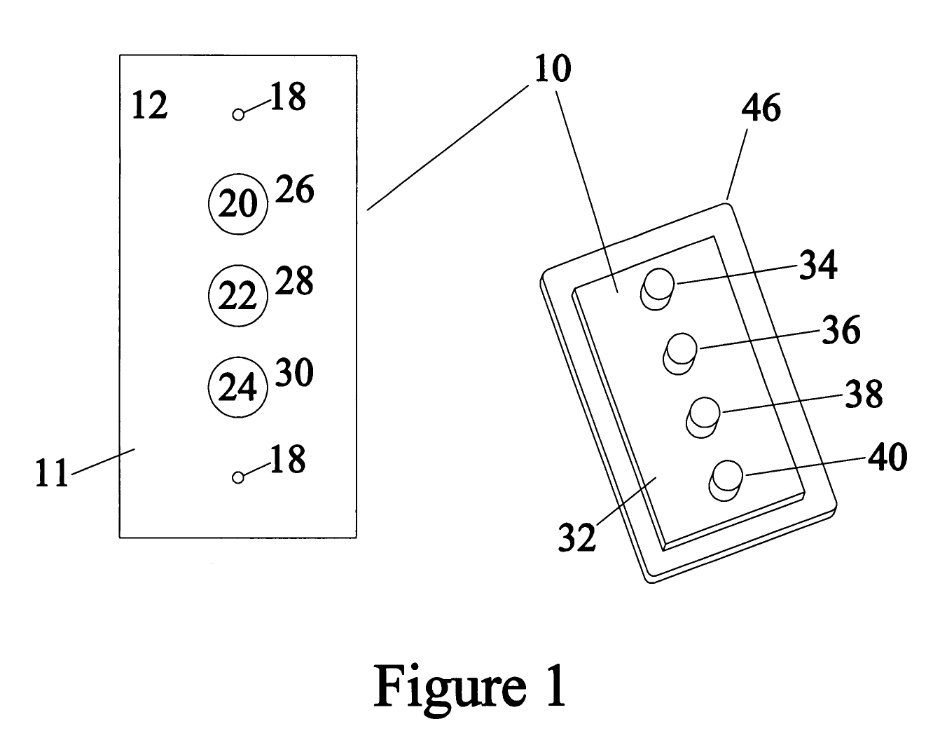

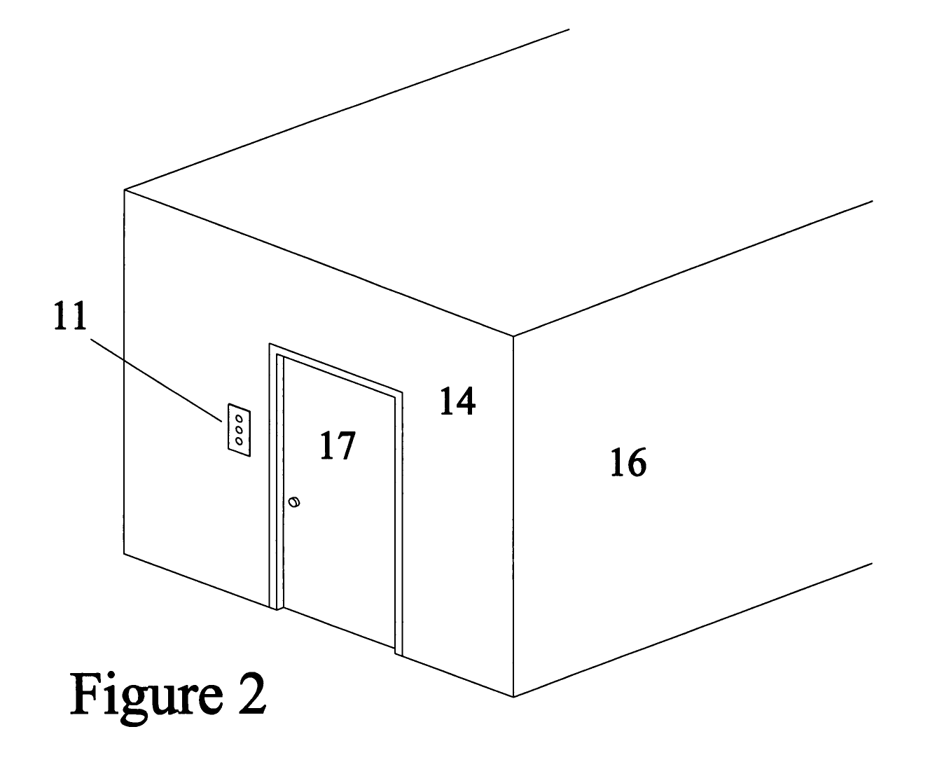

As shown in FIG. 1, the notification device 10 of the present invention includes a display unit 11 and a control mechanism 32. The display unit 11 is conveniently mounted on an exterior wall 14 of a room 16, as best shown in FIG. 2. The control mechanism 32 ideally has a shape and size suitable for being held in a user's hand, and is typically kept inside the room 16 so that an occupant (not shown) of the room 16 can use the control mechanism 32 to control a notice displayed on the display unit 11. Stationery or wall-mounted control mechanisms 32 are also possible. For example, a mounting bracket 46 may be attached to an interior wall of the room 16, so that the control mechanism 32 may be placed in the mounting bracket 46 and held in a convenient location for controlling the display unit 11 mounted outside the room 16.

The display unit 11 has a face plate 12, which may typically be of a similar size and shape to a single gang wall plate. A red indicator 20 is secured in a top portion 26 of the face 12, a yellow indicator 22 is secured in a middle portion 28 of the face 12, and a green indicator 24 is secured in a bottom portion 30 of the face 12. Thus, the display unit face 12 is reminiscent of a traffic light signal. The red indicator 20, when turned on, provides an intuitively obvious notice that an occupant of the room 16 prefers that no one proceed through the door 17 of the room 16. The yellow indicator 22, when activated, provides an equally understandable notice that an occupant of the room 16 prefers that someone outside the room 16 take the time to knock before entering. When the green indicator 24 is on, persons outside the room 16 are notified that unrestricted entry is permitted. By using the symbolism of a common traffic light signal, persons outside the room 16 readily understand each of the three possible notices to be conveyed on the display unit 11, even if the person viewing the notice is unable to read.

Each indicator 20, 22, 24 may be a light emitting diode of the appropriate color, or may be a white light with a tinted lens to provide a red, yellow, or green light, as appropriate. Care should be taken to use a light source which is clearly noticeable, but not overpowering.

Although it is beneficial to arrange the three indicators 20, 22, 24 in the same top to bottom fashion as is typically seen on traffic light signals, some variation in presentation may be useful without impeding the recognizable notices. For example, it is possible to make the red indicator 20 larger than the yellow indicator 22 and green indicator 24, if emphasis is needed on the red indicator 20. It is also possible to provide additional notices on the same display unit 11.

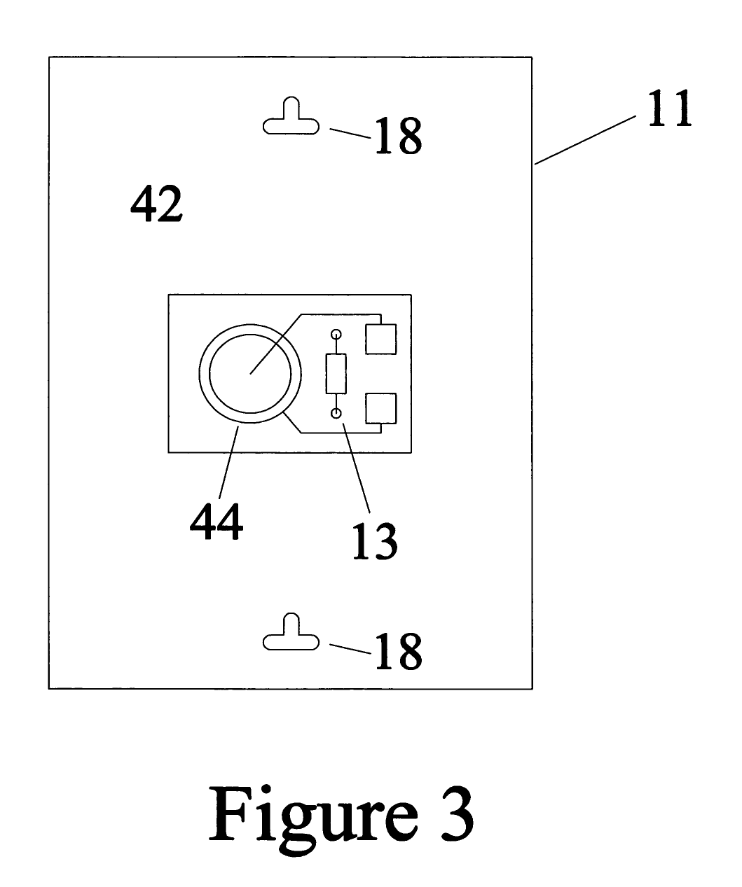

Typical electronic components 13 which are known in the prior art are connected to each indicator 20, 22, 24 to allow each indicator 20, 22, 24 to be remotely activated and deactivated by means of the control mechanism 32. The electronic components 13 include a power source 44 such as a battery or wired connection to a low voltage power source (not shown). The electronic components 13 may be housed in a box (not shown) with the display unit face 12 mounted on the front of the box, or may be attached to the rear 42 of the display unit face 12, as best shown in FIG. 3. The control mechanism 32 has a red indicator control 34, a yellow indicator control 36, and a green indicator control 38, as shown in FIG. 1. Each control 34, 36, 38 may be a button or other manually operated mechanism for sending a RF signal to activate the corresponding indicator 20, 22, 24 on the display unit 11. When multiple rooms 16 in the same building may utilize notification devices 10, it is beneficial to provide an identification code for each control mechanism 32 to link that control mechanism 32 to just the one display unit 11 which is mounted on the wall 14 of the room 16 in which that control mechanism 32 is being used. A power on/off control 40 may be provided on each control mechanism 32, to allow a user to turn the control mechanism 32 off and conserve battery power when the notification device 10 is not needed.

The display unit 11 can be mounted in a temporary manner, such as with adhesive strips (not shown) stuck to a wall 14, or with a more permanent attachment mechanism 18 such as screws, brads, or other fasteners. Thus, the display unit 11 can be permanently or removably attached directly to a wall 14 in proximity to a door 17 providing entry to a room 16. Alternatively, a box housing the electronic components 13 may be secured to a stud (not shown) of the wall 14, allowing the display unit face plate 12 to be flush with the wall 14, in a manner similar to a conventional light switch box and plate. The face 12 of the display unit 11 is therefore readily visible to those outside the room 16, ideally in a location on the wall 14 which is near the door 17 of the room 16. At the same time, the display unit 11 is no more obtrusive than a typical light switch, and therefore does not detract from room decor.

Although the present invention has been described in terms of the presently preferred embodiment, it is to be understood that such disclosure is purely illustrative and is not to be interpreted as limiting. Consequently, without departing from the spirit and scope of the invention, various alterations, modifications, or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

I claim:

1. A notification device for providing a notice outside of a room, comprising:
a. display unit suitable for mounting on an exterior wall of the room, which display unit has a face viewable by a person outside the room,
b. red indicator secured in a top portion of said face,
c. yellow indicator secured in a middle portion of said face,
d. green indicator secured in a bottom portion of said face, and
e. control mechanism for activating said red indicator, said yellow indicator, or said green indicator from inside the room.

2. A notification device according to claim 1, wherein said red indicator, said yellow indicator, and said green indicator are substantially similar in size.

3. A notification device according to claim 1, wherein said red indicator is substantially larger than said yellow indicator and said green indicator.

4. A notification device according to claim 1, wherein said display unit can be permanently or temporarily mounted on the exterior wall of the room.

5. A notification device according to claim 1, wherein said display unit face is significantly similar in size to a single gang wall plate.

6. A notification device according to claim 1, wherein said control mechanism includes a power control mechanism for turning power on or off at the display unit.

7. A method of notifying persons outside a room that the occupants of the room desire no entry, desire entry only after knocking, or desire unrestricted entry, said method comprising the steps of:
a. mounting on an exterior wall of the room a display unit with a face having a red indicator secured in a top portion of said face, a yellow indicator secured in a middle portion of said face, and a green indicator secured in a bottom portion of said face,
b. activating said red indicator by a control mechanism inside the room to notify persons outside the room that no entry is desired,
c. activating said yellow indicator by a control mechanism inside the room to notify persons outside the room that entry after knocking is desired, and
d. activating said green indicator by a control mechanism inside the room to notify persons outside the room that unrestricted entry is desired.
